(19) United States
(12) Patent Application Publication
(10) Pub. No.: US 2026/0063306 A1
(43) Pub. Date: Mar. 5, 2026

(54) COOKING APPARATUS

(71) Applicant: SAMSUNG ELECTRONICS CO., LTD., Suwon-si (KR)

(72) Inventors: Daehee KIM, Suwon-si (KR); Byounghoon MOON, Suwon-si (KR); Jiyoung SONG, Suwon-si (KR); Sunwoo HAN, Suwon-si (KR); Jiwon JEONG, Suwon-si (KR)

(73) Assignee: SAMSUNG ELECTRONICS CO., LTD., Suwon-si (KR)

(21) Appl. No.: 19/350,715

(22) Filed: Oct. 6, 2025

Related U.S. Application Data
(63) Continuation of application No. PCT/KR2025/012867, filed on Aug. 25, 2025.

(30) Foreign Application Priority Data
Sep. 5, 2024 (KR) 10-2024-0121097
Sep. 5, 2024 (KR) 10-2024-0121098
Dec. 23, 2024 (KR) 10-2024-0194732
Jul. 2, 2025 (KR) 10-2025-0088513

(51) Int. Cl. F24C 15/10; H05B 6/12

(52) U.S. Cl. CPC F24C 15/108; H05B 6/1209

(57) ABSTRACT

A cooking apparatus includes a main body, a display panel configured to display cooking information, a cooking plate arranged on an upper portion of the main body. The cooking plate includes a first plate including an opening at a position corresponding to the display panel and an inclined inner surface provided along a circumference of the opening, and a second plate configured to be seated in the opening formed at the position corresponding to the display panel such that the second plate is supported by the inclined inner surface of the first plate.

### CROSS-REFERENCE TO RELATED APPLICATIONS

This application is a continuation application of international application No. PCT/KR2025/012867, filed on Aug. 25, 2025, which claims priority under 35 U.S. C. § 119 to Korean Patent Applications No. 10-2024-0121097, filed on Sep. 5, 2024; No. 10-2024-0121098, filed on Sep. 5, 2024; No. 10-2024-0194732, filed on Dec. 23, 2024; and No. 10-2025-0088513, filed on Jul. 2, 2025, the disclosures of which are incorporated herein by reference in their entireties.

### TECHNICAL FIELD

The disclosure relates to a cooking apparatus with an improved structure.

### Background Art

A cooking apparatus is an appliance for heating and cooking an object to be cooked, such as food, and that may provide a number of functions related to cooking, such as heating, defrosting, drying, and sterilizing the object to be cooked. Cooking apparatuses may include gas cooktops that cook food using gas, and electric cooktops that cook food using electricity.

A gas cooktop, also known as a gas range, is an apparatus that cooks food by turning a lever to ignite and burn gas from a small generator.

An electric cooktop is an apparatus that cooks food by generating heat either directly or indirectly, using electricity.

Examples of electric cooktops include: induction cooktops, in which heat is generated in a vessel by a magnetic field formed in a coil; highlight (radiant) cooktops, which directly heat a heating element using electricity; hot plates, which heat a coil-shaped heating wire beneath a cast iron or coated hot plate; and halogen cooktops, which heat a cooking vessel with infrared power from a halogen lamp.

### Disclosure

### Technical Problem

An embodiment of the present disclosure provides a cooking apparatus in which an opening is formed in a first plate and a second plate is inserted into the opening to form a display portion of the cooking apparatus.

Technical tasks to be achieved in this document are not limited to the technical tasks mentioned above, and other technical tasks not mentioned will be clearly understood by those skilled in the art from the description below.

### Technical Solution

A cooking apparatus according to an embodiment of the present disclosure includes a main body, a display panel configured to display cooking information, a cooking plate arranged on an upper portion of the main body, wherein the cooking plate includes a first plate including an opening formed at a position corresponding to the display panel and an inclined inner surface provided along a circumference of the opening, and a second plate configured to be seated in the opening at the position corresponding to the display panel such that the second plate is supported by the inclined inner surface of the first plate.

A cooking apparatus according to an embodiment of the present disclosure includes a main body, a display panel received in the main body, a first plate arranged on an upper portion of the main body and in which an opening is formed at a position corresponding to the display panel, and a second plate arranged on the upper portion of the main body and identifiably arranged and seated in the opening formed at a position corresponding to the display panel, wherein the size of the opening is larger on an upper surface of the first plate than on a lower surface of the first plate.

### DESCRIPTION OF DRAWINGS

FIG. 1 illustrates a cooking apparatus according to an embodiment of the present disclosure.

FIG. 2 is an exploded view illustrating some configurations of the cooking apparatus according to an embodiment of the present disclosure in an exploded view.

FIG. 3 illustrates a cross-section of FIG. 1.

FIG. 4 is an enlarged view of the dotted line portion of FIG. 3.

FIG. 5 is an enlarged exploded view of some configurations of the cooking apparatus according to an embodiment of the present disclosure.

FIG. 6 is a side cross-sectional view of some configurations of FIG. 5.

FIG. 7 is an enlarged view of FIG. 6.

FIG. 8 illustrates a cross-sectional perspective view of some configurations of the cooking apparatus according to an embodiment of the present disclosure, taken along line A-A′ of FIG. 5.

FIG. 9 is an exploded view of some configurations of a cooking apparatus according to an embodiment of the present disclosure.

FIG. 10 is an enlarged cross-sectional view of some configurations of FIG. 9 assembled.

FIG. 11 is an exploded view of some configurations of the cooking apparatus according to an embodiment of the present disclosure.

FIG. 12 is an exploded view of some configurations of the cooking apparatus according to an embodiment of the present disclosure.

FIG. 13 is an enlarged cross-sectional view of the cooking apparatus according to an embodiment of the present disclosure.

FIG. 14 is an exploded view of some configurations of a cooking apparatus according to an embodiment of the present disclosure.

FIG. 15 is an enlarged view of the dotted line area of FIG. 14.

FIG. 16 is a cross-sectional view of some configurations in FIG. 15 assembled.

### MODES OF THE INVENTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, configurations, or combinations thereof, but do not preclude the presence or addition of one or more of the features, figures, steps, operations, elements, configurations, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

When an element is said to be “connected”, “coupled”, “supported,” “attached,” or “contacted” with another element, this includes not only when elements are directly connected, coupled, supported, attached, or contacted, but also when elements are indirectly connected, coupled, supported, attached, or contacted through a third element.

Throughout the description, when an element is “on” another element, this includes not only when the element is in contact with the other element, but also when there is another element between the two elements.

Further, as used in the disclosure, the terms “front”, “rear”, “top”, “bottom”, “side”, “left”, “right”, “upper”, “lower”, and the like are defined with reference to the drawings, and are not intended to limit the shape and position of each configuration. For example, a-Y direction where a second region is formed may be defined as the front, the Y direction where a first region is formed may be defined as the rear, and the left, right, upper, and lower directions may be defined based on this.

Hereinafter, various embodiments according to the present disclosure will be described in detail with reference to the accompanying drawings.

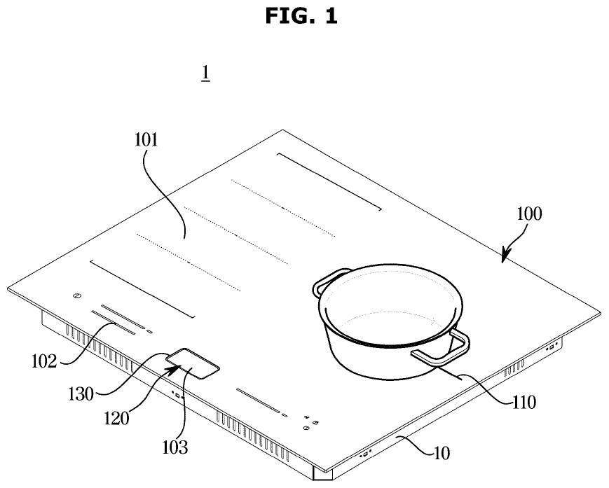

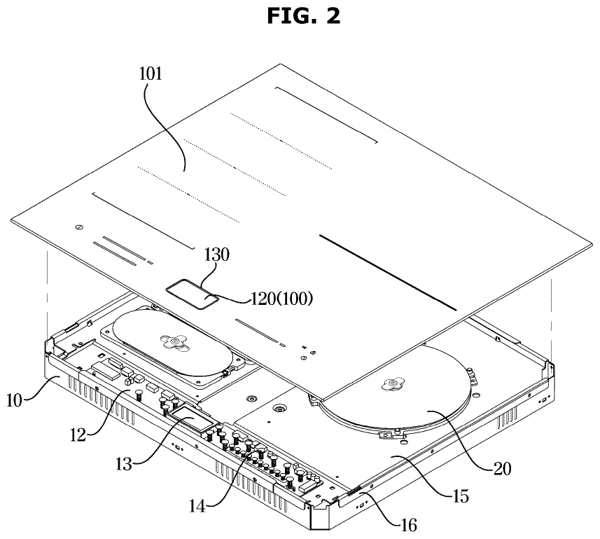

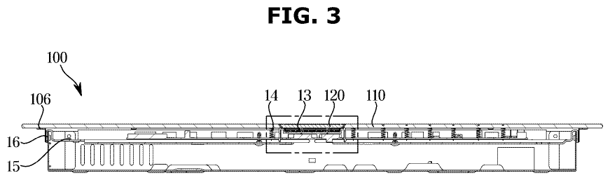

FIG. 1 illustrates a cooking apparatus according to an embodiment of the present disclosure. FIG. 2 illustrates some configurations of the cooking apparatus according to an embodiment of the present disclosure in an exploded view. FIG. 3 illustrates a cross-section of FIG. 1.

Referring to FIGS. 1 to 3, a cooking apparatus 1 may include a main body 10 forming an exterior of the cooking apparatus 1 and on which various parts constituting the cooking apparatus 1 are installed.

The cooking apparatus 1 may include a cooking plate 100 arranged on an upper side of the main body 10. The cooking plate 100 may have a flat plate shape on which a cooking vessel may be placed. In an example, the cooking plate 100 may include ceramic glass and/or tempered glass. For example, the cooking plate 100 may include heat-resistant glass that is resistant to heat.

The cooking plate 100 may include a variety of materials. The cooking plate 100 may have a non-light transmitting property. Furthermore, the cooking plate 100 may have characteristics capable of transmitting a touch signal to a circuit board 12 arranged below via touch.

The cooking apparatus 1 may include at least one heating source 20 for cooking food. The heating source 20 may be provided inside the main body 10 or on the cooking plate 100. The heating source 20 may be located below the cooking plate 100. In an embodiment of the present disclosure, the heating source 20 is illustrated as being an induction heating coil of an induction, but the ideas of the present disclosure is not limited thereto. The heating source 20 may include various embodiments capable of heating food provided in a cooking zone 101. For example, the heating source 20 may include various heating sources on a cooktop, such as an electric coil, an electric heater, a gas burner, and the like, that generate heat.

The cooking plate 100 may include the cooking zone 101 provided corresponding to the heating source 20. The cooking zone 101 may be formed on an upper surface of the cooking plate 100. The number and location of the cooking zones 101 are not limited to the accompanying drawings.

A user interface may be provided on one side of the cooking plate 100 to receive control commands from a user and display operation information of the cooking apparatus 1 to the user. However, the location of the user interface is not limited to being on the cooking plate 100 and may be arranged at various locations, such as on the front and/or side surfaces of the main body 10. The user interface may include a display portion 103 and an input portion 102.

The circuit board 12 may be disposed below the cooking plate 100. The circuit board 12 may include a display panel 13 and a touch portion 14. The circuit board 12 may include a printed circuit board assembly including a printed circuit board on which the display panel 13, switching elements, integrated circuit elements, and the like for implementing the user interface, are installed.

The display panel 13 may be arranged corresponding to the display portion 103 of the cooking plate 100. The display panel 13 may indicate whether food is being heated by the heating source 20. Accordingly, the user may check whether the food is being heated or not through the display portion 103.

The touch portion 14 may be arranged corresponding to the input portion 102 of the cooking plate 100. The touch portion 14 may receive a touch signal from the input portion 102. For example, the touch portion 14 may receive input in a capacitive touch method. However, the present disclosure is not limited thereto, and the touch portion 14 may also receive an input in a resistive touch method. The user may determine the degree to which the food is heated via the input portion 102.

When the heating source 20 is accommodated within the main body 10, the main body 10 may be provided with a seating plate 15 for seating the heating source 20. The main body 10 may include a first frame 16 configured to support the cooking plate 100. The first frame 16 may be configured such that the cooking plate 100 may be supported thereon. The first frame 16 may be formed by extending upwardly from all four ends of the seating plate 15. The first frame 16 may be configured such that the cooking plate 100 may be seated and supported on the main body 10.

The cooking plate 100 may be provided with a second frame 106. The cooking plate 100 may be configured to be supported by the first frame 16 of the main body 10. The second frame 106, corresponding to the first frame 16, may be arranged on a lower surface of the cooking plate 100.

The second frame 106 may be arranged to be in contact with the first frame 16 of the main body 10. The second frame 106 may be arranged such that the cooking plate 100 may be seated on the main body 10. The second frame 106 may be arranged on a periphery of the lower surface of the cooking plate 100. The second frame 106 may be attached to the lower surface of the cooking plate 100. The second frame 106 may be attached to the periphery of the lower surface of the cooking plate 100 via heat-resistant silicone. The second frame 106 may be provided in a plurality. The second frame 106 may be disposed on both sides and the rear of the cooking plate 100.

The coupling of the second frame 106 attached to the lower portion of the cooking plate 100 and the first frame 16 of the main body 10 may allow the cooking plate 100 to be seated on an upper portion of the main body 10.

The cooking plate 100 may include a first plate 110 and a second plate 120, and the cooking plate 100 may be provided as a single integrated structure (e.g., a sheet) by fitting the second plate 120 into the first plate 110. A bracket 130 may be provided between the second plate 120 and the first plate 110. The specific configuration of the cooking plate 100 will be described later with reference to other drawings.

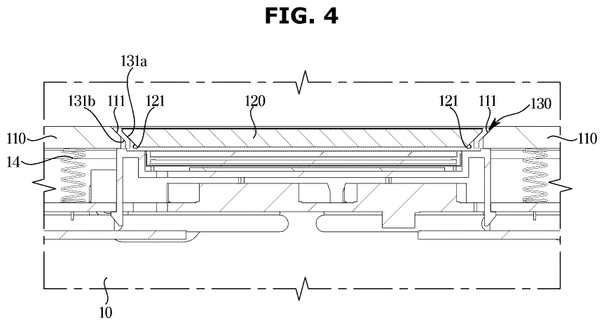

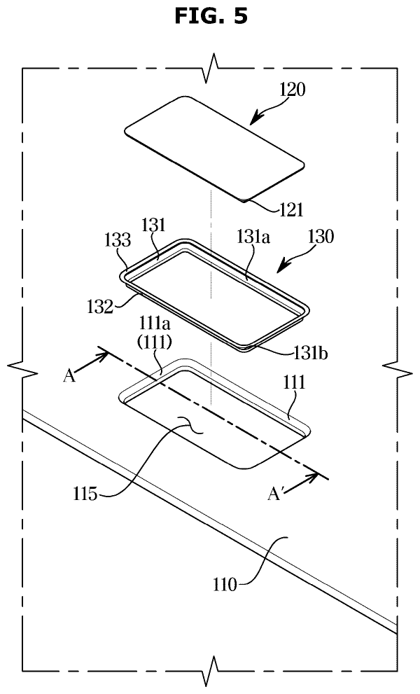

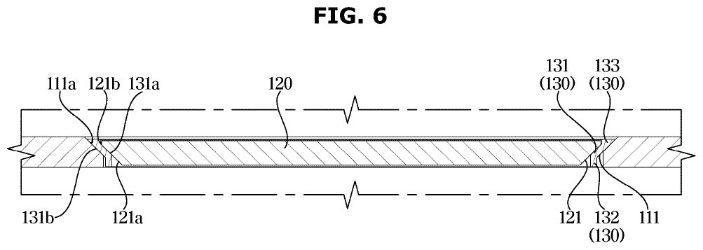

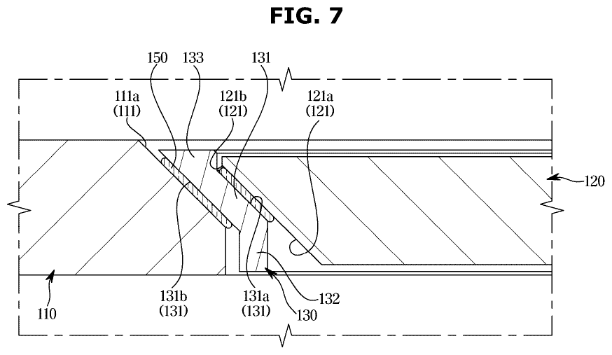

FIG. 4 illustrates an enlarged view of the dotted line portion of FIG. 3. FIG. 5 illustrates an enlarged exploded view of some configurations of the cooking apparatus according to an embodiment of the present disclosure. FIG. 6 illustrates a side cross-sectional view of some configurations of FIG. 5. FIG. 7 illustrates an enlarged view of FIG. 6.

Referring to FIGS. 4 to 7, the cooking plate 100 may include the first plate 110 and the second plate 120. The cooking zone 101 and the input portion 102 may be provided on the first plate 110. The display portion 103 may be provided on the second plate 120. Accordingly, the second plate 120 may include a substantially transparent material. The second plate 120 may be made of a material relatively more transparent than the first plate 110. The second plate 120 may include a transparent glass. The second plate 120 may include a heat-resistant material, such as heat-resistant glass or acrylic, and the second plate 120 may be processed to be identifiable.

The first plate 110 may include an opaque material. In other words, the first plate 110 may include colored glass. Accordingly, the cooking zone 101 and the input portion 102 of the cooking plate 100 may be arranged on colored glass. In other words, by using colored glass for the remaining portions of the cooking zone 101 and the input portion 102, except for the display portion 103 which requires transparent glass, the use of relatively expensive transparent glass compared to colored glass may be reduced. As a result, the manufacturing cost of the cooking plate 100 may be reduced. The first plate 110 may include an opening 115 on one side thereof for seating the second plate 120. The second plate 120 may be configured to be received in the opening 115.

The bracket 130 may be provided between the first plate 110 and the second plate 120. The bracket 130 may be seated on an inner side of the opening 115 of the first plate 110. The bracket 130 may be configured to support the second plate 120. The bracket 130 may be provided in a closed shape. The bracket 130 may be provided in a closed shape along an edge of the second plate 120. Furthermore, the bracket 130 may be provided in a closed shape along a circumference of an inner surface 111 of the opening 115 of the first plate 110.

The bracket 130 may be configured to be seated in the opening 115 of the first plate 110. The bracket 130 may be configured to support the second plate 120. The second plate 120 may be inserted and seated on an inner side of the bracket 130.

The bracket 130 may include a sealing portion 133, an inclined portion 131, and a support portion 132. The sealing portion 133 may be arranged on an upper portion of the bracket 130. An upper surface of the sealing portion 133 may be configured to cover an area in the opening 115 between an upper surface of the first plate 110 and an upper surface of the second plate 120.

The upper surface of the sealing portion 133 may be provided in a shape corresponding to a portion formed by the spacing between the upper surface of the first plate 110 and the upper surface of the second plate 120. In other words, the thickness of the sealing portion 133 may be approximately the same as the separation distance between the first plate 110 and the second plate 120.

The upper surface of the sealing portion 133 may be configured to form a unitary of design when forming the display portion 103 on the cooking plate 100. In other words, the upper surface of the sealing portion 133 may be configured to fill the empty space formed when the second plate 120 is inserted into the first plate 110, thereby creating a sense of unity between the first plate 110 and the second plate 120 to the user.

The upper surface of the sealing portion 133 may be arranged to be located relatively lower than the upper surface of the first plate 110. The upper surface of the second plate 120 may be arranged to be located relatively lower than the upper surface of the sealing portion 133. Accordingly, the upper surface of the second plate 120 may be arranged to be located below the upper surface of the first plate 110. This may prevent the upper surface of the second plate 120 from protruding above the upper surface of the first plate 110 even when manufacturing tolerances occur. This may prevent the bracket 130 from protruding above the upper surface of the first plate 110 even when manufacturing tolerances occur. As a result, the defect rate in the process of the cooking plate 100 may be reduced.

The bracket 130 may include the inclined portion 131 arranged to seat the second plate 120 in the opening 115 of the first plate 110. The inclined portion 131 may be provided between the sealing portion 133 and the support portion 132. In other words, the inclined portion 131 may be positioned in a middle portion of the bracket 130.

The inclined portion 131 of the bracket 130 may be configured to slope downwardly along the center of the opening 115 of the first plate 110. In other words, the perimeter of the inclined portion 131 may be configured to decrease downwardly. In other words, the internal area of the inclined portion 131 of the bracket 130 may be arranged to decrease downwardly.

The inclined portion 131 of the bracket 130 may include an inner inclined surface 131a formed on an inner side of the bracket 130 and an outer inclined surface 131b formed on an outer side of the bracket 130.

The inner inclined surface 131a may be arranged to abut against a side surface 121 of the second plate 120. The inner inclined surface 131a may be arranged to support the side surface of the second plate 120 upwardly.

The second plate 120 may be configured to be received on the inner side of the bracket 130. The side surface of the second plate 120 may be beveled and provided in an approximately wedge shape. Specifically, the side surface of the second plate 120 may be configured to slope downward along the center of the second plate 120. The side surface of the second plate 120 may be arranged to have the same slope as the inner inclined surface 131a of the bracket 130. In other words, the slope of the side surface of the second plate 120 may be provided corresponding to that of the inner inclined surface 131a of the bracket 130.

More specifically, the second plate 120 may include an inclined first side surface 121a and a second side surface 121b provided in a vertical direction. The first side surface 121a may be arranged to abut against the inclined portion 131 of the bracket 130. The second side surface 121b may be arranged to abut against the sealing portion 133 of the bracket 130.

Meanwhile, the inner surface 111 of the first plate 110 may be arranged to be inclined. Specifically, the inner surface 111 of the opening 115 of the first plate 110 may include an inclined inner surface 111a arranged to be inclined.

The inclined inner surface 111a may be provided to be inclined downwardly along the center of the opening 115. The inclined inner surface 111a may be configured to support the bracket 130. The bracket 130 may be supported through surface contact with the inclined inner surface 111a, and accordingly, the load of the bracket 130 and the second plate 120 may not be concentrated in the direction of gravity but may be distributed through the inclined inner surface 111a.

The inclined portion 131 of the bracket 130 may be configured to be supported by the inner surface 111 of the first plate 110. The outer inclined surface 131b formed on the outer side of the bracket 130 may be arranged to abut against the inner surface 111 of the first plate 110. In other words, the inner surface 111 of the opening 115 of the first plate 110 may be configured to support the bracket 130.

The bracket 130 may be configured to be received on the inner side of the opening 115 of the first plate 110. The outer inclined surface 131b of the bracket 130 may be inclined and provided in an approximately wedge shape. Specifically, the outer inclined surface 131b of the bracket 130 may be arranged to be inclined downwardly along the center of the opening 115. The outer inclined surface 131b of the bracket 130 may be provided to have the same inclination as the inclined inner surface 111a of the opening 115 of the first plate 110.

The wedge-shaped inclined structure may distribute the load in the vertical and horizontal directions to prevent the stress from being concentrated in one place. Accordingly, the first plate 110 and the second plate 120 may be reliably coupled.

The support portion 132 may be provided below the inclined portion 131. The support portion 132 may be configured to extend in the vertical direction. The support portion 132 may be configured to limit the tilting of the bracket 130 within the opening 115 of the first plate 110. The support portion 132 may be configured such that the bracket 130 is stably seated and balanced within the opening 115 of the first plate 110.

The cooking plate 100 may further include a sealing member 150 and a support member 240 in addition to the bracket 130 including the inclined portion 131.

The sealing member 150 may be provided between the first plate 110 and the bracket 130, and between the second plate 120 and the bracket 130. Specifically, the sealing member 150 may be provided between the inner surface 111 of the first plate 110 and the outer inclined surface 131b of the inclined portion 131, and between the inner inclined surface 131a of the inclined portion 131 and the side surface 121 of the second plate 120. As a result, the bracket 130 may be more securely fixed between the first plate 110 and the second plate 120.

Furthermore, the sealing portion 133 may be configured such that the sealing member 150 is not exposed to the upper surface of the cooking plate 100. As a result, the manufacturing process of the cooking plate 100 may be simplified by eliminating an additional process of removing the sealing member 150 exposed on the cooking plate 100.

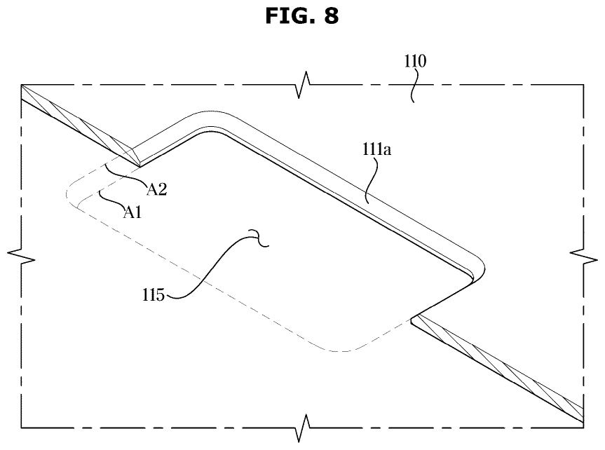

FIG. 8 illustrates a cross-sectional perspective view of some configurations of the cooking apparatus according to an embodiment of the present disclosure, taken along line A-A′ of FIG. 5.

Referring to FIG. 8, the opening 115 of the first plate 110 may penetrate the first plate 110 in the vertical direction. The inclined inner surface 111a of the opening 115 may be arranged to be inclined downward in a direction toward the center. Accordingly, the area of the opening 115 may become smaller toward the lower side. The area A1 of the opening 115 at the lower surface of the first plate 110 may be smaller than the area A2 of the opening 115 at the upper surface of the first plate 110. In other words, the size of the opening 115 may be larger on the upper surface side of the first plate 110 than on the lower surface side of the first plate 110.

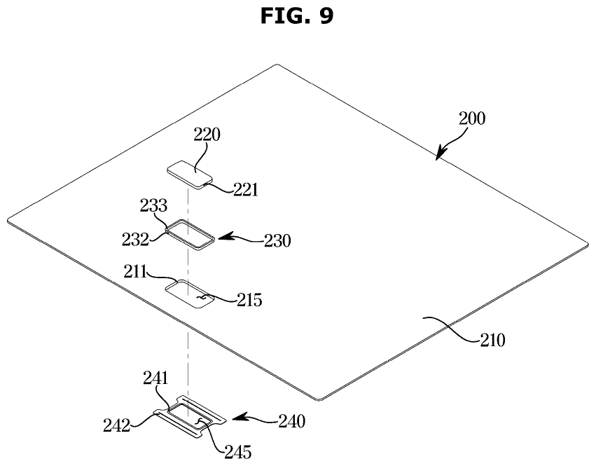

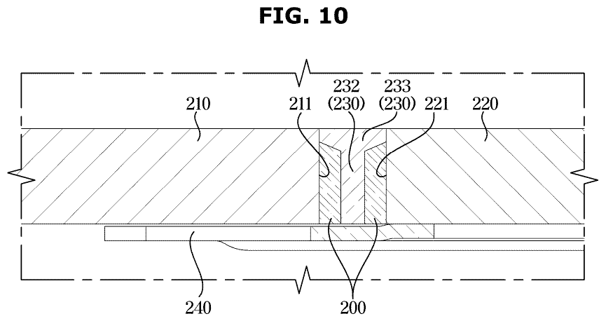

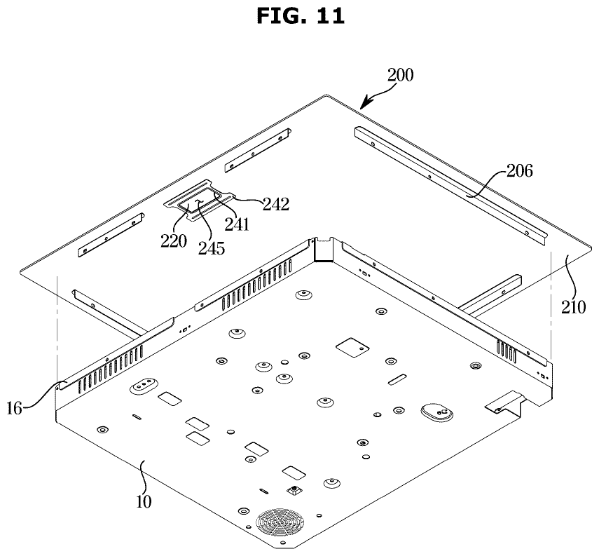

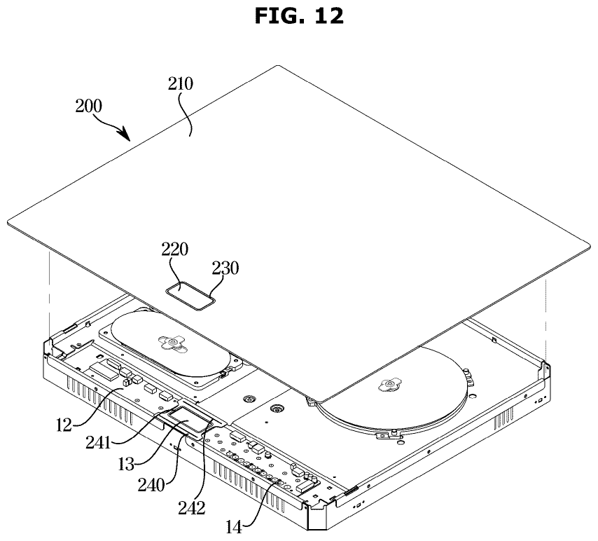

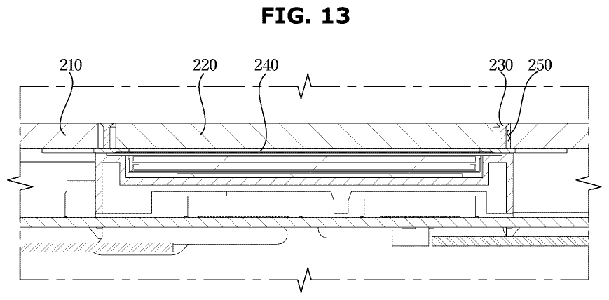

FIG. 9 illustrates an exploded view of some configurations of the cooking apparatus according to an embodiment of the present disclosure. FIG. 10 illustrates an enlarged cross-sectional view of some configurations of FIG. 9 assembled. FIG. 11 illustrates an exploded view of some configurations of the cooking apparatus according to an embodiment of the present disclosure. FIG. 12 illustrates an exploded view of some configurations of the cooking apparatus according to an embodiment of the present disclosure. FIG. 13 illustrates an enlarged cross-sectional view of the cooking apparatus according to an embodiment of the present disclosure.

A cooking plate will be described with reference to FIGS. 9 to 13 in which the bracket does not include an inclined portion. Furthermore, in the following description, configurations that are substantially the same as or similar to those described with reference to FIGS. 4 to 7 may be omitted or briefly described for ease of description.

Referring to FIGS. 9 to 13, a cooking plate 200 may include a first plate 210, a second plate 220, a bracket 230, a support member 240, and a sealing member 250. The second plate 220 may be provided within an opening 215 of the first plate 210. The bracket 230 may be provided between the first plate 210 and the second plate 220. In this case, the bracket 230 may not include an inclined portion. In other words, the bracket 230 may include only a sealing portion 233 and a support portion 232. The sealing portion 233 may be arranged to contact an inner surface 211 of the opening 215 of the first plate 210 and a side surface 221 of the second plate 220. The support portion 232 may be arranged below the sealing portion 233. The support portion 232 may be arranged to extend vertically.

The support portion 232 may be arranged to be spaced apart from the inner surface 211 of the first plate 210 and the side surface 221 of the second plate 220, respectively. The sealing member 250 may be arranged between the first plate 210 and the support portion 232, and between the support portion 232 and the second plate 220.

The sealing member 250 may be provided with an adhesive material. The sealing member 250 may be configured to contact the inner surface 211 of the first plate 210 and the support portion 232, respectively. As a result, the sealing member 250 may be configured to attach the bracket 230 to the first plate 210. In other words, the bracket 230 may be attached to the inside of the first plate 210 via the sealing member 250.

The sealing member 250 may be configured to contact the side surface 221 of the second plate 220 and the support portion 232, respectively. As a result, the sealing member 250 may be configured to attach the second plate 220 to the bracket 230. In other words, the second plate 220 may be attached to the inside of the bracket 230 via the sealing member 250.

Accordingly, the second plate 220 may be configured to be attached to the inside of the opening 215 of the first plate 210 via the sealing member 250. In other words, the second plate 220, the bracket 230, and the first plate 210 may be coupled via the sealing member 250.

The support member 240 may be attached to a lower surface of the first plate 210. Accordingly, the support member 240 may be configured to support the lower sides of the bracket 230 and the second plate 220. Specifically, the support member 240 may be configured to prevent the bracket 230 and the second plate 220, bonded by the adhesive force of the sealing member 250, from sagging in the direction of gravity under the influence of gravity. As a result, the bracket 230 and the second plate 220 may be stably secured within the opening 215 of the first plate 210.

More specifically, the support member 240 may include an attachment surface 242 attached to the lower surface of the first plate 210, a support surface 241 supporting the lower sides of the bracket 230 and the second plate 220, and a second opening 245 provided in a shape corresponding to the display panel 13.

The support surface 241 may be arranged along a perimeter of the second opening 245. In other words, the support surface 241 may be arranged along the perimeter of the bracket 230 on the lower side of the bracket 230. The thickness of the support surface 241 may be greater than the separation distance between the first plate 210 and the second plate 220. As a result, the support member 240 may be configured to support the lower sides of the bracket 230 and the second plate 220.

The attachment surface 242 may be arranged to extend horizontally from the support surface 241. Accordingly, the attachment surface 242 may be configured to be coupled with the first plate 210 on the outside of the support surface 241. For example, the attachment surface 242 may be attached to the first plate 210 with double-sided tape or adhesive.

However, the location of the support member 240 is not limited to the lower side of the cooking plate 200. For example, the support member 240 may be located on the upper side of the display panel 13 without being attached to the lower side of the first plate 210. In other words, the support member 240 may be attached to the upper side of the display panel 13.

In other words, the support member 240 may include different shapes or be attached at different locations arranged to support the lower sides of the bracket 230 and the second plate 220 between the cooking plate 200 and the display panel 13.

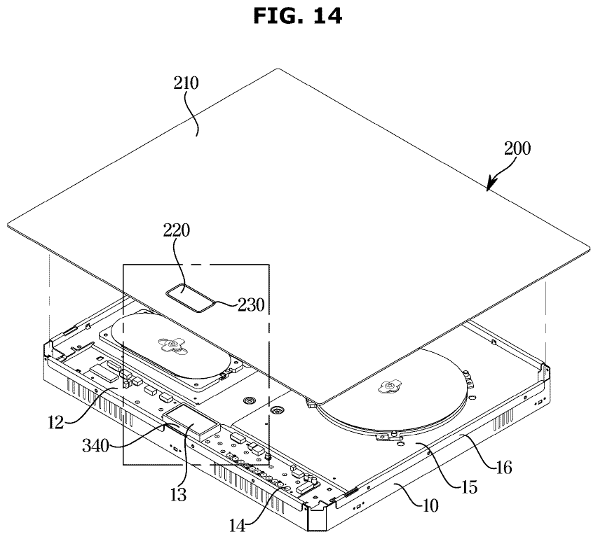

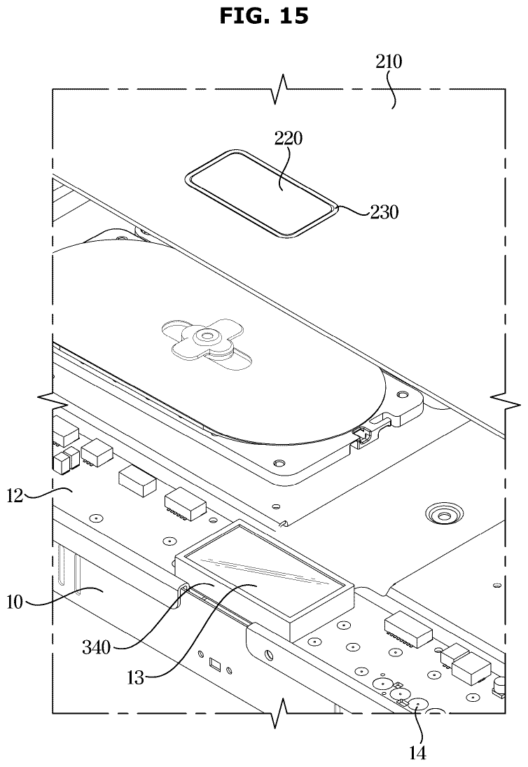

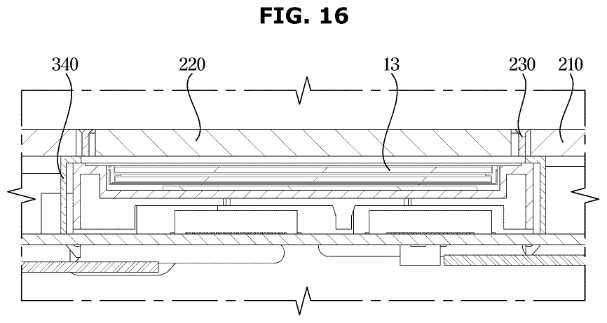

FIG. 14 illustrates an exploded view of some configurations of a cooking apparatus according to an embodiment of the present disclosure. FIG. 15 illustrates an enlarged view of the dotted line area of FIG. 14. FIG. 16 illustrates a cross-sectional view of some configurations assembled in FIG. 15.

Referring to FIGS. 14 to 16, a support member 340 may be provided in various shapes as long as it performs the function of supporting the bracket 230 and the second plate 220. For example, the upper surface of the support member 340 according to an embodiment may include a hole for exposing the display panel 13, and at the same time a support surface configured to surround the display panel 13 for supporting the lower sides of the bracket 230 and the second plate 220 of the cooking plate 200. The support member 340 may be configured to cover the side surface of the display panel 13.

In other words, the support member 340 may be shaped to surround the display panel 13. In other words, the support member 340 may be a casing that encloses the display panel 13. Specifically, the side surface of the support member 340 may be configured to wrap around the side surface of the display panel 13. The upper surface of the support member 340 may be configured to support the lower sides of the bracket 230 and the second plate 220.

The upper surface of the support member 340 may be configured to contact the lower surface of the support portion 232 of the bracket 230 and the lower surface of the second plate 220. The thickness of the upper surface of the support member 340 may be arranged to be greater than the separation distance between the first plate 210 and the second plate 220.

The cooking apparatus 1 according to the spirit of the present disclosure may include the main body 10, the display panel 13 configured to display cooking information, and the cooking plate 100 arranged on an upper portion of the main body 10, wherein the cooking plate 100 may include the first plate 110 including the opening 115 formed at a position corresponding to the display panel 13, and the inclined inner surface 111a provided along a circumference of the opening 115, and the second plate 120 configured to be seated in the opening 115 formed at the position corresponding to the display panel 13 and to be supported by the inclined inner surface 111a of the first plate 110.

The cooking apparatus may further include the bracket 13 arranged between the first plate 110 and the second plate 120 and configured to be supported by the inclined inner surface 111a of the first plate 110, and to support the second plate 120.

The bracket may include the inclined portion 131, and the inclined portion 131 may include the inner inclined surface 131a configured to couple to the second plate 120 to support the second plate 120, and the outer inclined surface 131b configured to couple to the inclined inner surface 111a of the first plate 110.

The inclined inner surface 111a may be configured to slope downwardly in a direction toward a center of the opening 115.

The outer inclined surface 131b of the bracket 130 may have substantially the same slope as the inclined inner surface 111a of the first plate 110.

The side surface 121 of the second plate 120 may be configured to slope downwardly in a direction toward a center of the second plate 120, a slope of the side surface 121 of the second plate may be substantially the same as a slope of the inclined inner surface 111a of the first plate 110.

The cooking plate 100 may be configured such that the second plate 120 is fitted into the opening 115 of the first plate 110.

The second plate 120 may be provided to be relatively more transparent than the first plate 110.

The cooking apparatus may further include the sealing member 150 arranged between the bracket 130 and the first plate 110, and arranged between the bracket 130 and the second plate 120.

The cooking apparatus may further include the support member 240 configured to support the second plate 120 from below.

The support member 240 may include the attachment surface attached to a lower side of the first plate 110 and a support surface configured to support a lower surface of the bracket 130 and a lower surface of the second plate 120.

The bracket 130 may include the sealing portion 133 at an upper end thereof, and the sealing portion 133 may have a thickness corresponding to a separation distance between the first plate 110 and the second plate 120.

An upper surface of the sealing portion 133 may be configured to be located below an upper surface of the first plate 110.

The upper surface of the sealing portion 133 may be configured to be located above an upper surface of the second plate 120.

The bracket 130 may be configured such that the sealing member 150 is not exposed to an upper surface of the cooking plate.

The cooking apparatus 1 according to the spirit of the present disclosure includes the main body 10, the display panel 13 received in the main body 10, the first plate 110 arranged on an upper portion of the main body 10 and in which the opening 115 is formed at a position corresponding to the display panel 13, and the second plate 120 arranged on the upper portion of the main body 10 and identifiably arranged and seated in the opening 115 formed at a position corresponding to the display panel 13, wherein the size of the opening 115 is larger on an upper surface of the first plate 110 than on a lower surface of the first plate 110.

The first plate 110 may include the inclined inner surface 111a arranged along a circumference of the opening 115.

The inclined inner surface 111a of the first plate 110 may be configured to support the second plate 120 upwardly.

The cooking apparatus may further include the bracket 13 arranged between the first plate 110 and the second plate 120 and configured to be supported by the inclined inner surface 111a of the first plate 110, and to support the second plate 120.

The cooking apparatus may further include the sealing member 150 arranged between the bracket 130 and the first plate 110, and arranged between the bracket 130 and the second plate 120.

According to the spirit of the present disclosure, the cooking plate of the cooking apparatus may use the expensive transparent second plate material only in the area corresponding to the display portion, thereby reducing the manufacturing cost of the cooking plate.

According to the spirit of the present disclosure, the cooking plate may support the second plate through the inclined portion of the bracket arranged between the first plate and the second plate, thereby simplifying the manufacturing process of forming the display portion on the cooking plate.

According to the spirit of the present disclosure, the bracket may include the sealing portion at the upper end thereof, which may prevent the sealing member between the second plate and the first plate from being exposed to the upper end of the cooking plate.

The effects according to an aspect of the disclosure are not limited to the effects mentioned above, and other effects not mentioned will be clearly understood by those of ordinary skill in the art to which the present disclosure pertains from the description below.

While the present disclosure has been particularly described with reference to exemplary embodiments, it should be understood by those of skilled in the art that various changes in form and details may be made without departing from the spirit and scope of the present disclosure.

1. A cooking apparatus comprising:
a main body;
a display panel configured to display cooking information; and
a cooking plate arranged on an upper portion of the main body;
wherein the cooking plate includes:
a first plate including an opening formed at a position corresponding to the display panel, and an inclined inner surface provided along a circumference of the opening, and
a second plate configured to be seated in the opening at the position corresponding to the display panel such that the second plate is supported by the inclined inner surface of the first plate.

2. The cooking apparatus of claim 1, further comprising a bracket arranged between the first plate and the second plate, and configured to be supported by the inclined inner surface of the first plate and to support the second plate.

3. The cooking apparatus of claim 2, wherein the bracket includes an inclined portion comprising:
an inner inclined surface configured to couple to the second plate to support the second plate, and
an outer inclined surface configured to couple to the inclined inner surface of the first plate such that the bracket is supported by the first plate.

4. The cooking apparatus of claim 1, wherein the inclined inner surface slopes downwardly in a direction toward a center of the opening.

5. The cooking apparatus of claim 3, wherein the outer inclined surface of the bracket has a same slope as the inclined inner surface of the first plate.

6. The cooking apparatus of claim 1, wherein
a side surface of the second plate slopes downwardly in a direction toward a center of the second plate; and
a slope of the side surface of the second plate is same as a slope of the inclined inner surface of the first plate.

7. The cooking apparatus of claim 1, wherein the second plate is seated into the opening of the first plate such that the second plate is fitted into the opening of the first plate and the cooking plate is configured as a single integrated structure.

8. The cooking apparatus of claim 7, wherein the second plate is more transparent than the first plate.

9. The cooking apparatus of claim 2, further comprising a sealing member arranged between the bracket and the first plate, and an other sealing member arranged between the bracket and the second plate.

10. The cooking apparatus of claim 9, further comprising a support member coupled to a lower surface of the first plate and configured to support the second plate from below.

11. The cooking apparatus of claim 10, wherein the support member further comprises an attachment surface attached to the lower surface of the first plate and a support surface configured to support a lower surface of the bracket and a lower surface of the second plate to support the second plate from below.

12. The cooking apparatus of claim 2, wherein the bracket further comprises a sealing portion at an upper end of the bracket, the sealing portion having a thickness corresponding to a separation distance between the first plate and the second plate such that the sealing portion fills a space corresponding to the separation distance.

13. The cooking apparatus of claim 12, wherein an upper surface of the sealing portion is below an upper surface of the first plate.

14. The cooking apparatus of claim 13, wherein the upper surface of the sealing portion is above an upper surface of the second plate.

15. The cooking apparatus of claim 9, wherein the bracket is configured such that the sealing member and the other sealing member are not exposed to an upper surface of the cooking plate.
